(19) United States
(12) Patent Application Publication
(10) Pub. No.: US 2005/0098639 A1
(43) Pub. Date: May 12, 2005

(54) Temperature control system

(75) Inventor: Michael R. DeLuca, Mt. Laurel, NJ (US)

Correspondence Address: IP GROUP OF DLA PIPER RUDNICK GRAY CARY US LLP, 1650 MARKET ST, SUITE 4900, PHILADELPHIA, PA, 19103, US

(73) Assignee: Lux Products Corporation

(21) Appl. No.: 10/706,107

(22) Filed: Nov. 12, 2003

(51) Int. Cl. F23N 5/20; G05D 23/00; F28D 1/00; F24F 11/00; F28F 1/00; G01M 1/38; G05B 21/00; G05B 15/00; G05B 13/00

(52) U.S. Cl. 236/46 R; 236/47; 236/94; 700/276; 165/238

(57) ABSTRACT

The invention involves a system for the control of the temperature of a medium within a space by utilizing a temperature-modifying device. It may include a programmable controller connected for controlling a thermal output of the temperature-modifying device to achieve the desired temperature, and an interface connected for providing information to and from the programmable controller, the interface having at least one substantially linearly moveable member with at least a position for setting a program within the programmable controller and setting the programmable controller to control the temperature-modifying device.

### BACKGROUND

The field of the invention is that of temperature control systems for controlling a system for heating and/or cooling a medium to maintain a predetermined set point temperature, and more particularly to programmable thermostats that have multiple program settings.

It has been a longstanding problem in the water and air temperature control systems used in homes and offices to efficiently regulate the ambient temperature to maintain the desired level, while minimizing the amount of energy expended by the heating/cooling apparatus. The temperature control needs of a home or office are not constant over time and may, in fact, vary substantially depending on the time of day or day of the week. Historically, thermostats were highly inefficient in this regard due to the fact that only one set point temperature could be maintained.

In response to this, digital and programmable thermostats were developed, which allowed for the programming of one or more set points for the thermostat, such as based upon the time of day or day of the week. Many of these thermostats utilize a microprocessor into which the user inputs the desired temperature setting information by way of a keypad or complex arrangement of buttons and switches. For example, U.S. Pat. Nos. 4,460,125 and 4,319,711 disclose a programmable wall thermostat that uses a keypad for setting the program, setting the clock, operating the thermostat, and switching therebetween. Likewise, U.S. Pat. Nos. 4,337,822, 4,277,784, and 4,264,034 all disclose a digital thermostat that uses a complex arrangement of a plurality of switches and sliding members for determining these settings.

These thermostats have the distinct disadvantage that they are cumbersome to program and are complicated to use. This often results in an improper setting of the thermostat and, consequently, an inefficient use of the heating/cooling apparatus. Moreover, it often occurs that the users are unaware that they have improperly programmed the thermostat or that they have not finished the programming of the thermostat and that the thermostat is not properly controlling temperature. Again, this results in an inefficient use of the heating/cooling apparatus.

Therefore, a thermostat is needed which allows users to easily select among different functionality, such as setting one or more programs for various set point temperatures, setting the program clock, and operating the thermostat, while simultaneously assuring individuals that they have programmed the thermostat correctly and have, in fact, controlled the thermostat to its desired operating condition.

### SUMMARY OF THE INVENTION

Embodiments of the invention include a system for the control of the temperature of a medium within a space by utilizing a temperature-modifying device. These may include a programmable controller connected for controlling a thermal output of the temperature-modifying device to achieve the desired temperature, and an interface connected for providing information to and from the programmable controller, the interface having at least one substantially linearly moveable member with at least a position for setting a program within the programmable controller and setting the programmable controller to control the temperature-modifying device.

These embodiments preferably include the ability to select from among a plurality of programs, such as weekday program, a weekend program, and a daily program, and may be used with any temperature-modifying device, such as HVAC systems, geothermal systems, gas furnaces, natural gas furnaces, electric furnaces, gas water heaters, and electric water heaters.

### BRIEF DESCRIPTION OF THE DRAWINGS

FIG. 1 is a block diagram of a programmable thermostat.

FIG. 2(a) is a front elevation of a preferred embodiment.

FIG. 2(b) is a cut-open rear elevation of a preferred embodiment.

FIGS. 3(a)-(b) are a schematic of a preferred embodiment.

### DETAILED DESCRIPTION

The invention will be understood more fully from the detailed description given below and from the accompanying drawings of preferred embodiments of the invention; which, however, should not be taken to limit the invention to a specific embodiment but are for explanation and understanding.

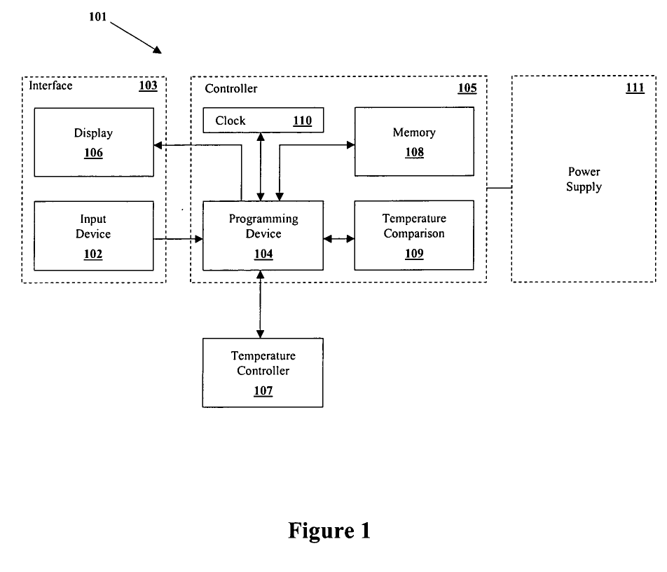

FIG. 1 contains a block diagram of an embodiment of a programmable thermostat. Those of ordinary skill in the art will appreciate that the invention is not limited thereto and may comprise any device or configuration of components capable of operating in the manner of the invention. In the preferred embodiment disclosed herein, information regarding the desired set point temperature, date, or time for each program is inputted to thermostat 101 by the user through input device 102 in interface 103. Interface 103 is connected to programming device 104 of controller 105 in such a way that programming device 104 receives information inputted at input device 102, and preferably displays this information on display device 106.

Programming device 104 also controls the operation of the temperature-modifying device 107, which is typically a heating/cooling system for the medium whose temperature is being controlled, such as heating ventilation and air conditioning (“HVAC”) systems, geothermal systems, gas, natural gas, or electric furnaces or water heaters, etc. Programmable device 104 preferably stores the information received from input device 102 in memory 108, along with an algorithm or program for operating temperature-modifying device 107 in accordance with this information.

Programming device 104 may comprise any device capable of operating in the manner of the invention, such as a logic circuit on a logic board, a microprocessor, or other integrated circuit. Similarly, memory 108 may comprise electronic memory, such as RAM, SRAM, or DRAM, and the like, in an integrated circuit, such as a PROM, EPROM, or EEPROM and the like. Memory 108 may also form part of programming device 104. Display device 106 is also not particularly limited and may comprise, for example, an electronic display, such as an LCD, LED, and the like. Input device 102 may include pressure sensitive buttons, keypads, or any other device or arrangement of devices that are capable of entering the appropriate information. The interoperation of such devices is well known to those of ordinary skill in the art.

A comparison device 109 is preferably used to compare ambient temperature of the medium to be controlled with the desired control temperature, as determined by programming device 104 and stored in memory 108. Comparison device 109 may detect the current ambient temperature by using a conventional temperature-sensing device, such as a thermistor, thermocouple, or other type of temperature transducer.

A clock 110 is connected with connected with programming device 104 in order to provide time related information thereto for use in connection with the operation of programming device 104 and its program of temperature control. Time related information from clock 110 may also be stored in memory 108 and shown on display 106. Clock 110 may comprise any device for providing time related information, such as a voltage controlled oscillator (VCO), crystal oscillator, and the like, along with associated circuitry. The time related information provided by clock 110 is not limited and may comprise, for example, chronological time information, such as year, month, day, hour, minutes, and/or seconds, or synchronization information for programming device 104 (which may be used to calculate this information). Clock 110 may also form a part of programming device 104.

The operation of controller 105 and/or interface 103 is preferably powered by power supply 111. Power supply 111 is not particularly limited, but may comprise any source of power capable of operating controller 105 and interface 103, such as household current (e.g., 120 v AC at 60 Hz), or one or more batteries (e.g., 9 v DC).

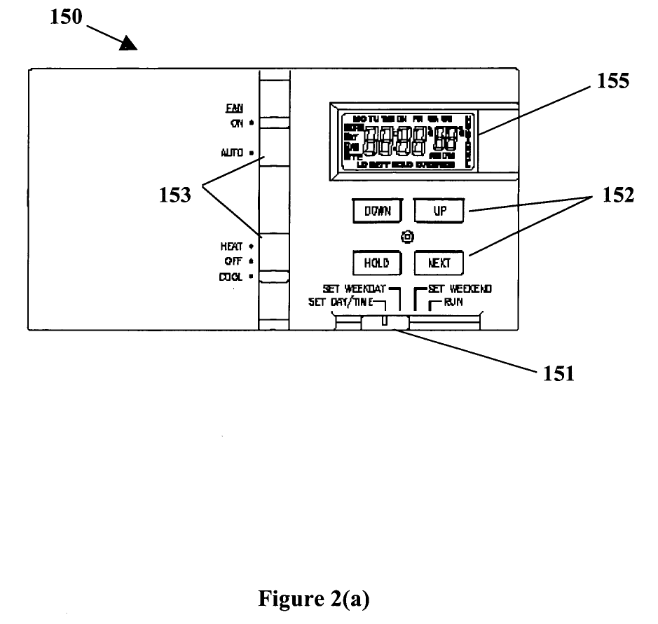

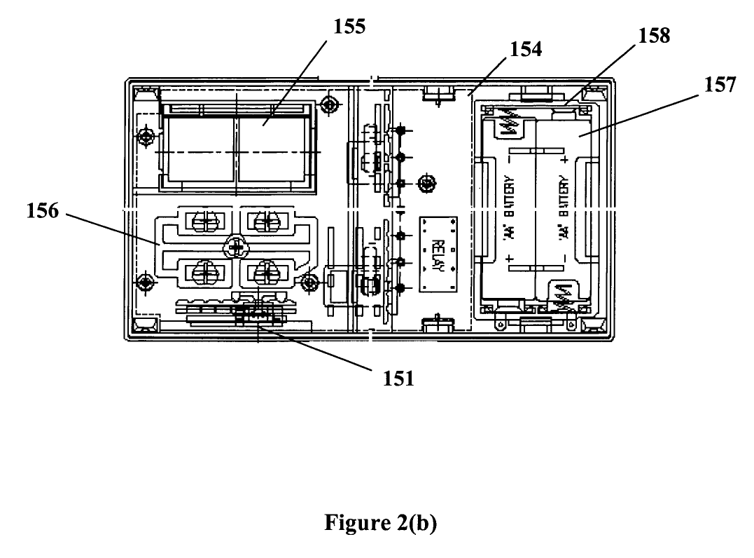

FIGS. 2(a)-(b) are drawings illustrating a preferred embodiment. Those of ordinary skill in the art will appreciate that the invention is not limited thereto and may comprise any device or configuration of components capable of operating in the manner of the invention.

In one embodiment, a programmable thermostat 150 includes a substantially linearly moveable member, such as a sliding switch 151 may be used as part of input device 102 in interface 103 (FIG. 1). Sliding switch 151 may include a plurality of selectable positions to allow the user to more easily determine which information is being inputted to controller 105 and what aspect of controller 105 is being programmed. Sliding switch 151 may include selectable positions for setting at least one program and possibly a plurality of such programs, such as a weekday program, a weekend program, (or one or more daily programs, such as Saturday or Sunday, or any day of the week), and positions for setting the date/time of clock 110, and a position for running or operating the thermostat.

By moving sliding switch 151 to one of the setting positions, the thermostat user can input data via the pressure sensitive buttons 152. This information may be used by programming device 104 (FIG. 1) to generate the appropriate program or set the appropriate date/time related information. Sliding switches 153 may be used to designate whether the thermostat is in a heating mode or a cooling mode, such as when operating an HVAC system as a temperature modifying device, or to designate whether an air handler or fan is continuously in operation or turned on and off automatically.

The use of a substantially linearly moveable member provides significant advantages over conventional programmable thermostats in providing for an intuitive separation of programming functions, which, in turn, allows the user to better organize the operation of the thermostat. Although a preferred embodiment is shown in FIGS. 2(a)-(b), other equivalent devices will be

The controller may be implemented as a logic circuit on logic board 154, which is electrically connected to an LCD display 155. Sliding switch 151 and pressure sensitive buttons 152 are electrically connected to logic board 154 by electrical contacts 156. Power may be supplied to the system via batteries 157 (in this example, two 1.5 v AA batteries, although not limited thereto), which are electrically connected to logic board 154 by battery housing 158.

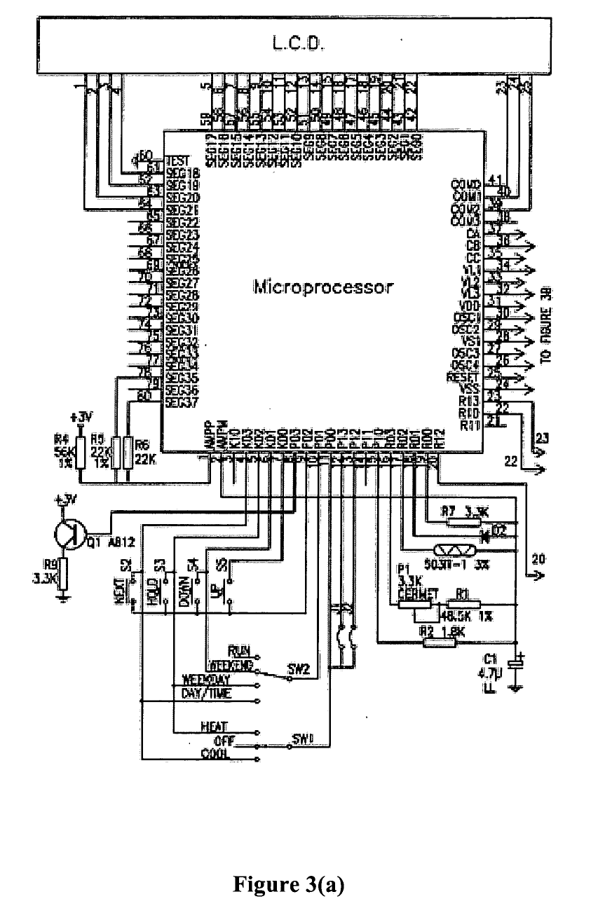

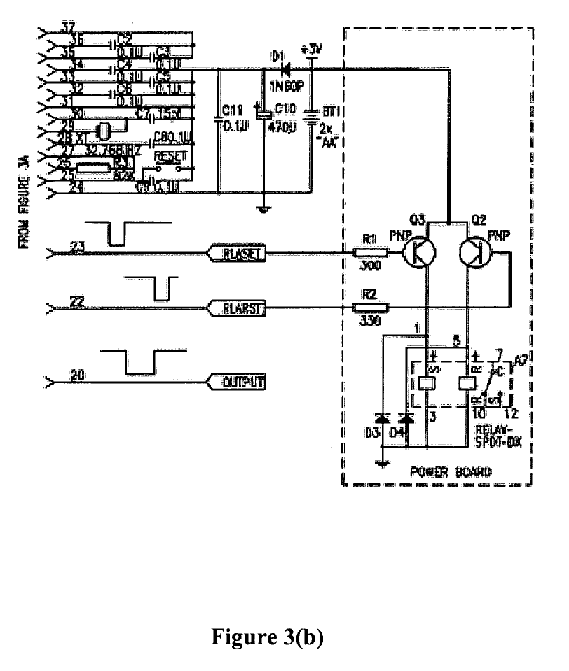

A schematic a preferred embodiment is illustrated in FIGS. 3(a)-(b). As shown in FIGS. 3(a)-(b), a microprocessor is powered by a DC power board, and, in turn, powers an LCD display. The microprocessor has a plurality of outputs to individual segments on the LCD display for outputting information thereto to be viewed by the user. The microprocessor also includes the plurality of inputs/outputs to a temperature modifying device and to a series of switches (e.g., next, hold, down, and up). One of these switches SW2, is selectable in this example, between a weekday program, a weekend program, date and time selection, and running or operating the thermostat. By selecting one of these positions in SW2, the user may designate which aspect of the program of temperature control may be inputted into the microprocessor using the remaining switches. Of course, those of ordinary skill in the art will appreciate that this is only one possible embodiment of the invention and is not eluded thereto.

While the invention as disclosed herein has been described in relation to specific embodiments thereof, it is understood that the invention is not limited to the particular embodiment disclosed herein, but only as set forth in the appended claims. It will be appreciated that various components known to those of skill in the art may be substituted for those described herein without departing from the spirit and scope of the invention as set forth in the appended claims. For example, the input device may include a pressure keypad or a series of contact switches instead of the pressure switches disclosed herein. The display device may also include an LED display or other illuminated display mechanisms, or any of a number of conventional mechanical display mechanisms such as gauges or the like. The invention may be used in connection with any device that controls temperature.

1. An apparatus for the control of the temperature of a medium within a space by utilizing a temperature-modifying device, said apparatus comprising:
a controller connected for controlling a thermal output of said temperature-modifying device to achieve said desired temperature, and
an interface connected for providing information to and from said controller, said interface having at least one substantially linearly moveable member with at least one position for setting at least one program within said programmable controller and a distinct position for running said temperature-modifying device.

2. The apparatus of claim 1, wherein said interface further includes a position for setting a clock for use with said program.

3. The apparatus of claim 1, wherein said interface comprises separate positions for setting a plurality of programs.

4. The apparatus of claim 3, wherein said plurality of programs include one or more selected from the group consisting of a weekday program, a weekend program, and a daily program.

5. The apparatus of claim 1, wherein said controller further comprises an implementing circuit, a temperature comparitor, and a memory.

6. The apparatus of claim 5, wherein said implementing circuit, said temperature comparitor, and said memory incorporate an integrated circuit having a microprocessor and a programmable memory chip.

7. The apparatus of claim 1, wherein said interface further comprises a display.

8. The apparatus of claim 7, wherein said display incorporates an LCD.

9. The apparatus of claim 1, wherein said temperature-modifying device is one or more selected from the group consisting of an HVAC system, a geothermal system, a gas furnace, a natural gas furnace, an electric furnace, a gas water heater, and an electric water heater.

10. An apparatus for the control of the temperature of a medium within a space by utilizing a temperature-modifying device, said apparatus comprising:
a logic circuit for comparing an existing temperature of said medium to a temperature desired to be achieved of said medium, and controlling a thermal output of said temperature-modifying device to achieve said desired temperature of said medium;
a memory for storing information received from said logic circuit;
an interface connected for inputting information to said logic circuit, said interface including at least one substantially linearly moveable member having at least a first position for setting a program within said logic circuit, a second position for setting a clock for use with said program within said logic circuit, and a third position for running said temperature-modifying device; and
a display for displaying information processed by said logic circuit.

11. (canceled)

12. The apparatus of claim 10, wherein said interface comprises separate positions for setting a plurality of programs.

13. The apparatus of claim 12, wherein said plurality of programs include one or more selected from the group consisting of a weekday program, a weekend program, and a daily program.

14. The apparatus of claim 10, wherein said logic circuit comprises a microprocessor.

15. The apparatus of claim 10, wherein said display incorporates an LCD.

16. The apparatus of claim 10, wherein said temperature-modifying device is one or more selected from the group consisting of an HVAC system, a geothermal system, a gas furnace, a natural gas furnace, an electric furnace, a gas water heater, and an electric water heater.

17. A thermostat for the control of the temperature of a medium within a space by utilizing a temperature-modifying device comprising:
a sensor for sensing ambient temperature;
a microprocessor for receiving said ambient temperature from said sensor and comparing said ambient temperature to a set point temperature, said microprocessor having an output for sending an output signal to said temperature-modifying device based upon said comparison;
an interface connected for inputting information to said microprocessor, said interface including a substantially linearly moveable member having more than one position for setting a plurality of programs within said microprocessor, and an additional position for running said temperature-modifying device; and
a display for displaying information received from the microprocessor.

18. The thermostat of claim 17, wherein said plurality of programs include one or more selected from the group consisting of a weekday program, a weekend program, and a daily program.

19. The thermostat of claim 17, wherein said temperature-modifying device is one or more selected of HVAC system, a geothermal thermal system, a gas furnace, a natural gas furnace, an electric furnace, a gas water heater, and an electric water heater.
